(19) United States
(12) Patent Application Publication
(10) Pub. No.: US 2004/0193505 A1
(43) Pub. Date: Sep. 30, 2004

(54) Sales support device

(75) Inventors: Tadatsugu Ishii, Kawasaki (JP); Koji Kawazoe, Inagi (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/784,181

(22) Filed: Feb. 24, 2004

(30) Foreign Application Priority Data
Mar. 28, 2003 (JP) 2003-91424

(51) Int. Cl. G06F 17/60

(52) U.S. Cl. 705/26

(57) ABSTRACT

A sales support device is constructed to assign a customer terminal of a customer a piece of customer identifying information related to each individual customer, receive selected commercial product information related to a commercial product selected by the customer, store a database with the customer identifying information and the selected commercial product information related to the customer in a way that makes them related to each other, receive the customer identifying information from a trader terminal of a sales trader having the customer identifying information, and link the trader terminal to the selected commercial product information, in the database, related to the customer.

### BACKGROUND OF THE INVENTION

The invention relates to a sales support technology when making mail-order sales.

Generally, on a general-purpose network such as the Internet, etc., there is administered a so-called shopping site for transactions of commercial products by sales by electronic communications that displays an information about the commercial products on this network.

On the occasion of utilizing the shopping site, a customer browses the information of the commercial products via the network from on an information processing terminal such as an existing computer, etc. Further, on the occasion of utilizing the shopping site, the customer browses the information on the commercial product by use of a network Browser (browsing) application program installed into the computer. Then, the customer selects a desired commercial product from on a screen of the Browser application program. The information on the desired commercial product is transmitted to a terminal of a sales trader who sells the commercial product via the network from the customer-sided computer.

By the way, normally, on the shopping site, there is an unclear point in the detailed information on the commercial product or in a shopping procedure, this is dealt with as below. Namely, on the shopping site, main query items are opened on the site. Alternatively, on the shopping site, the shop staff to the sales trader responds to the queries from the customers by phone or E-mails, etc.

Further, on the shopping site, when selling the commercial products (e.g., ready-made articles) which specifications or types are predetermined, the customer can easily refer to the information on the commercial products. Further, on the shopping site, the customer can purchase after gaining the understanding of the commercial product. If commercial products of which contents such as specifications or attachments; etc. change in response to a request of the customer, however, there arise, for example, there arise the following problems, when the commercial products having a large number of options and diversified combinations.

Namely, on the shopping site, if a customer unfamiliar to an operation of a computer or having poor knowledge about the commercial product, the customer is hard to search out the commercial product that meets the customer's own desire on the site screen. Moreover, a sales trader also is hard to precisely respond to a query from the customer side about the shopping site.

It is noted that, as a sales support technology on the shopping site, there is disclosed a technology (refer to, e.g., Japanese Patent Application Publication No. 2002-42009) wherein the customer side and the sales trader side share sales information by referring to the same screen.

### SUMMARY OF THE INVENTION

The technology in the Prior Patent Application, on the shopping site, supports the customer to select the commercial product. But this technology does not take it into account to offer the commercial products that accept requests and desires of the customers.

The invention was made in view of the items given above and aims at a solution thereof by providing a sales support technology capable of reflecting the customer request easily and exactly on the occasion of selling the commercial product via the network.

The invention adopts the following means in order to solve the problems.

Namely, in the invention, customer identifying information related to each individual customer is assigned to a customer terminal of the customer. Further, in the invention, selected commercial product information related to a commercial product selected by a customer is received from the customer terminal. Then, in the invention, a database is stored with the customer identifying information related to the customer, and the selected commercial product information related to the customer, to be related to each other. Moreover, in the invention, the customer identifying information is received from a trader terminal of a sales trader storing the customer identifying information. Then, the trader terminal is connected to the database stored with the selected commercial product information related to the customer in accordance with the customer identifying information.

In the invention, the access to the customer identifying information related to each customer and to the selected commercial product information is established from on the trader terminal of the commercial product sales trader. Hence, according to the invention, when selling the commercial product on a shopping site or the like, as for a customer-sided request for the commercial product, the customer request can be reflected easily and exactly on the side of the commercial product sales trader.

Further, in the invention, assigning the customer identifying information, when receiving a request to connecting to the device from the customer terminal.

According to the invention, the customer identifying information needed on the occasion of connected to the selected commercial product information of the customer is transmitted to the trader terminal on the side of the commercial product sales trader. Thereby, the invention is feasible to easily link to trader terminal to the selected commercial product information of the customer.

Moreover, in the invention, request information about a request for a commercial product desired by the customer may be received from the customer terminal and transmitted to the trader terminal.

According to the invention, the customer request for the commercial product is transmitted to the trader terminal on the side of the commercial product sales trader, and therefore the customer request can be easily reflected in the selected commercial product information of the customer.

Then, in the invention, the selected commercial product information of the customer may be updated related to the operation toward the trader terminal.

According to the invention, the selected commercial product information of the customer can be updated from on the trader terminal. Hence, in the invention, the customer can be provided with the selected commercial product information containing the commercial product information which the customer request is reflected in.

Moreover, in the invention, the selected commercial product information of the customer may be updated in accordance with the update information given from the trader terminal.

In the invention, the selected commercial product information of the customer can be updated by transmitting from the trader terminal the update information which the customer request is reflected in. According to the invention, the selected commercial product information of the customer can be updated.

Moreover, the invention may be a program for actualizing any one of the functions given above. Further, in the invention, this program may be recorded on a readable-by-computer recording medium.

Still further, the invention may be a device for actualizing any one of the functions given above.

### DESCRIPTION OF THE DRAWINGS

FIG. 1 is a schematic view of a network for actualizing a shopping site according to an embodiment of the invention.

FIG. 2 shows one example of an outline of architecture of a sales support device according to the embodiment.

FIG. 3 is a schematic view of a system, illustrating a sales support process according to the embodiment.

FIG. 4 is a schematic view on the occasion that a customer queries a commercial product trader about a request for a commercial product in a process example according to the embodiment.

FIG. 5 is a schematic view on the occasion that the customer queries the commercial product trader about the request for the commercial product in the process example according to the embodiment.

FIG. 6 shows one example of a shopping cart database in the process example according to the embodiment.

FIG. 7 is a schematic view illustrating a process of rewriting selected commercial product information of the customer in response to a customer request in the process example according to the embodiment.

### DETAILED DESCRIPTION OF THE INVENTION

A preferred embodiment of the invention will be described with reference to the drawings.

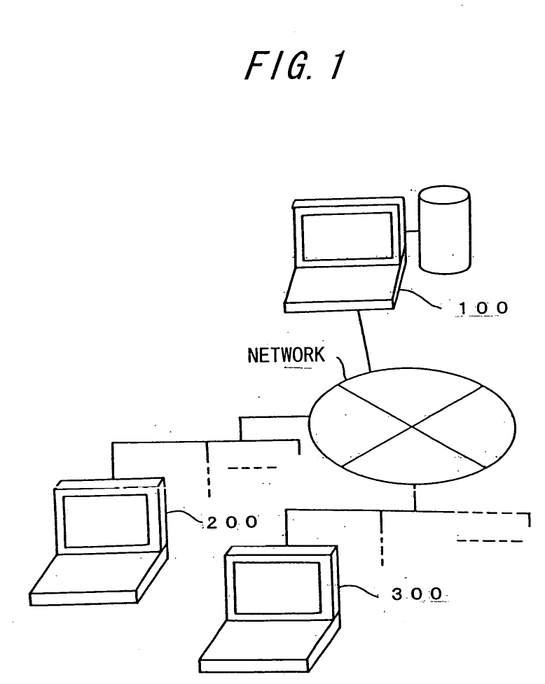

A sales support device in the embodiment of the invention will be explained based on the drawings in FIGS. 1 through 7.

In the following description, the embodiment gives an explanation about a process between a customer side and a sales trader side on a shopping site utilizing this sales support device.

<System Architecture>

FIG. 1 is a schematic view of a network for actualizing the shopping site according to the embodiment. A network in the embodiment is configured by use of the Internet (which is a data transfer network on TCP/IP: Transmission Control Protocol/Internet Protocol), and so on. Connected to the network are a sales support device 100 of the invention, a trader terminal 200 provided on the side of a commercial product sales trader who administers the shopping site and a customer terminal 300.

<Architecture of Device>

The sales support device 100 according to the embodiment is one example of what introduces (installs) a sales support program for actualizing a sales support method of the invention into an information processing device such as a computer, etc.

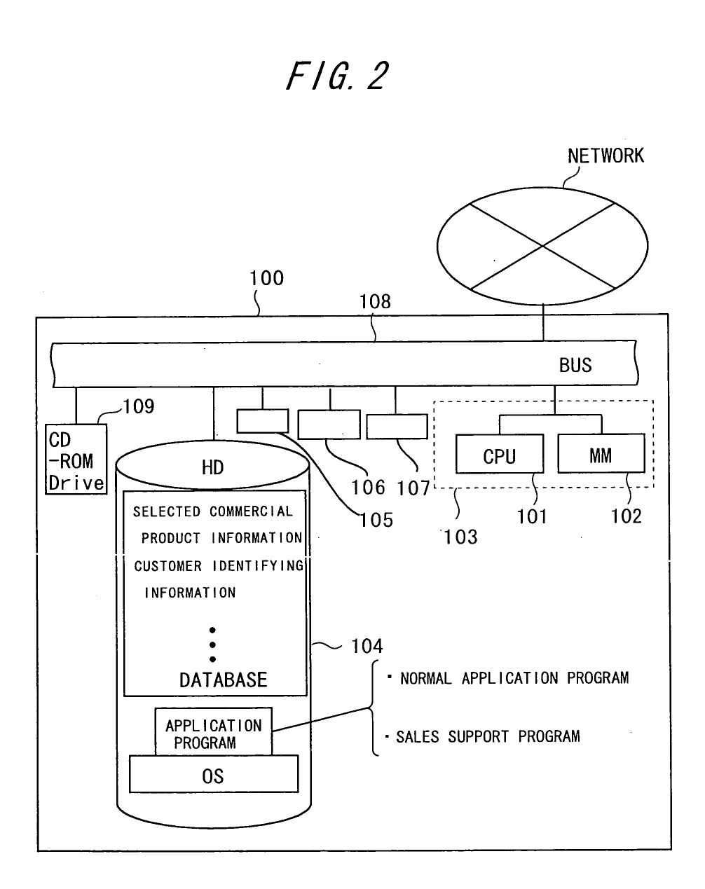

FIG. 2 is an example of an outline of architecture of the sales support device 100 according to the embodiment. At first, the sales support device 100 is provided with an information processing unit 103, constructed of a CPU (central processing unit)) 101 and a main memory (MM) 102, for executing processes based on an application program.

A storage device 104 is connected via a bus 108 to the information processing unit 103. Note that the storage device 104 normally involves using a large-capacity storage medium such as a hard disk device, etc.

Then, the storage device 104 is installed with an operating system (OS) needed for the sales support device 100 to normally function.

Further, other application programs to be generally used are installed into the storage device 104.

Furthermore, the storage device 104 is installed with a sales support program created for actualizing the sale support method of the invention and executable by the information processing device such as the computer.

These programs are provided to the sales support device 100 in a way of their being stored on an unillustrated storage medium such as a CD-ROM, and so on., Further, these programs are installed into the storage device 104 in an executable state via a CD-ROM drive device 109, etc. shown in FIG. 2. Note that the sales support device 100 may receive this program by use of the network and may, after installing it into the storage device 104, load the main memory 102 with it. Moreover, the sales support device 100 may be a device that loads the received program directly into the main memory 102.

Then, The CPU 101 loads (reads) the sales support program into the main memory 102 from the storage device 104 and executes it as the necessity may arise, thereby actualizing a variety of units in the information processing device for actualizing the sales support method as those of the present invention.

An interior of the storage device 104 is provided with a database required for actualizing the sales support method of the invention. Various categories of data stored in this database will be explained.

The database is stored with pieces of customer identifying information related to individual customers. Further, the database is stored with pieces of selected commercial product information and the customer identifying information.

Moreover, input unit and output unit are connected via the bus 108 to the information processing unit 103 of the sales support device 100.

One example of the input unit and the output unit of the sales support device 100 will be given. To begin with, an input device such as a keyboard 107 or a mouse, etc. for a user to input various pieces of information such as a pass word, etc., is provided as the input unit related to password input unit of the invention. Further, as the output unit, an output device such as a display 106 or a printer 105, etc. is connected via the bus 108 to the information processing unit 103. Note that the sales support device 100 of the invention may also be an information processing device (for example, a server device) having none of these input/output unit.

Next, device architectures of the trader terminal 200 and the customer terminal 300 according to the embodiment will be explained. In the embodiment, the device architecture and the operation of each of the trader terminal 200 and the customer terminal 300, are the same as those of the sales support device 100. Accordingly, the explanations of the same architecture and operation as those of the sales support device 100 are omitted. It is to be noted that a Browser application program for browsing various categories of sites such as the shopping site, etc. via the Internet is installed into the storage device 104 of each of the trader terminal 200 and the customer terminal 300 in the embodiment.

Note that a method such as CGI (Common Gateway Interface) or JavaScript, etc. for enabling a creation of a Web page on which a process is dynamically executed related to an input from the user in a WWW (World Wide Web) server of the network like the Internet, is utilized on the Browser application program according to the embodiment. Then, communication of the information between the customer and the sales trader on the shopping side according to the embodiment involves using the Web page technology.

<Example of Process>

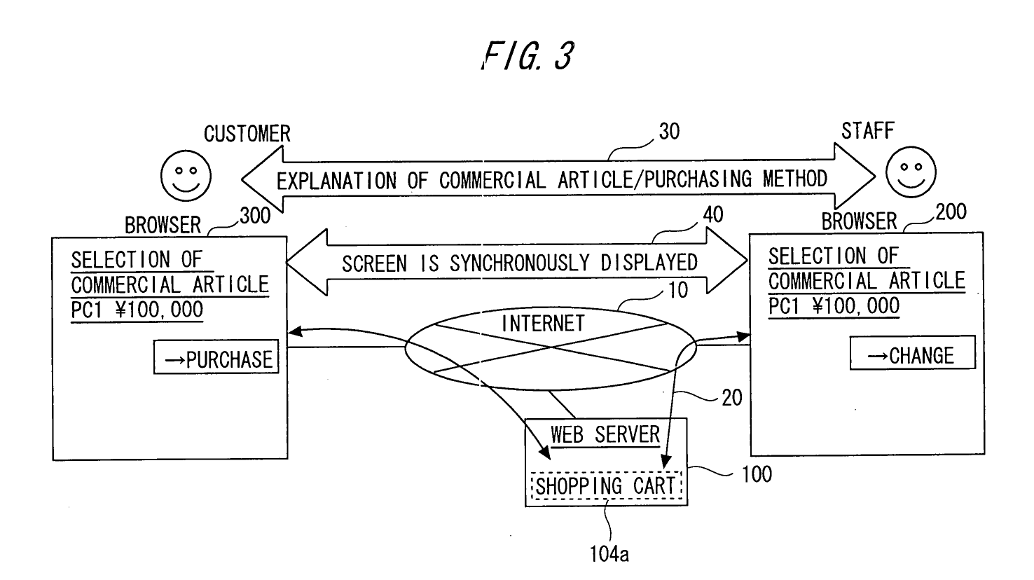

Next, a sales support process on the shopping site according to the embodiment will be described by use of FIGS. 3 through 7.

FIG. 3 is a schematic view of the system, illustrating the sales support process according to the embodiment. In an example of this process, the process on the occasion that a customer purchases a computer (PC 1) sold by the commercial product sales trader by utilizing the customer terminal 300, is shown by way of one example. The customer terminal 300 and the trader terminal 200 of the commercial product sales trader are connected to each other via the network (Internet) and through the sales support device 100 (the Web server) according to the embodiment.

The sales support device 100 transmits and receives (arrowheads 10 in FIG. 3) pieces of commercial product-related information such as commercial product selection information, etc. inputted to the Web page on the shopping site displayed on a screen (unillustrated) of the customer terminal 300. Further, the sales support device 100 accepts operations (arrowheads 20) on the side of the commercial product sales trader in response to a request from the customer on the shopping site Web page displayed on a screen (unillustrated) of the trader terminal 200. Then, the sales support device 100 stores the database of the storage device 104 with the commercial product selection information of every customer as a virtual shopping cart in accordance with the customer identifying information related to each individual customer.

On the occasion of utilizing the shopping site in this process, pieces of information about a description of the commercial product to be purchased or a purchase method, etc. are exchanged (arrowheads 30) between the customer and the commercial product sales trader. Moreover; on the occasion of utilizing the shopping site in this process, a Browser screen of the customer terminal 300 is synchronously displayed (arrowheads 40) on the Browser screen of the trader terminal 200. Therefore, in this process, on the occasion of purchasing the commercial product by utilizing the shopping site, the commercial sales trader and the customer can share the information related to the commercial product.

Next, in this process example, a specific processing procedure of the sales support device 100 will be explained.

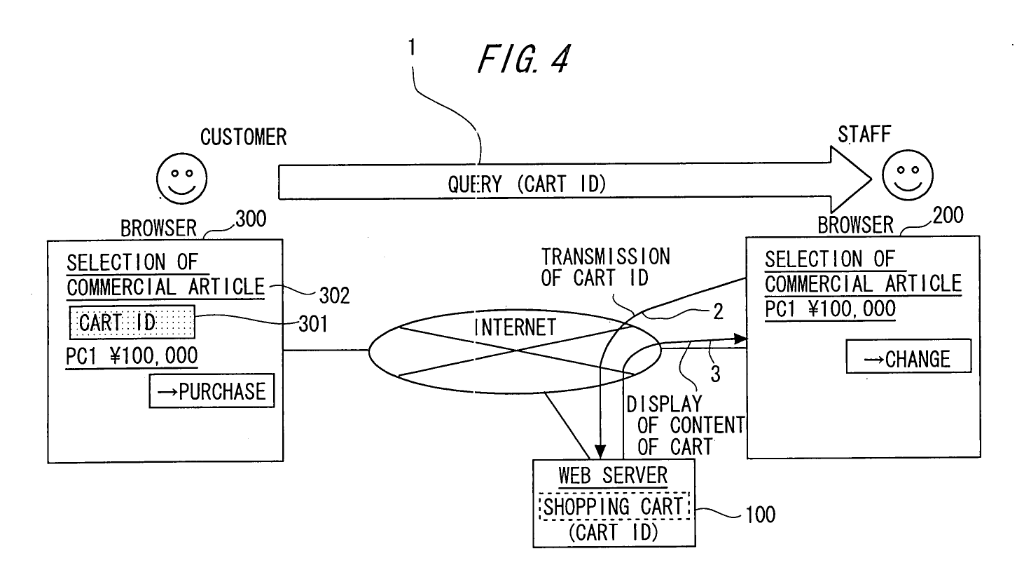

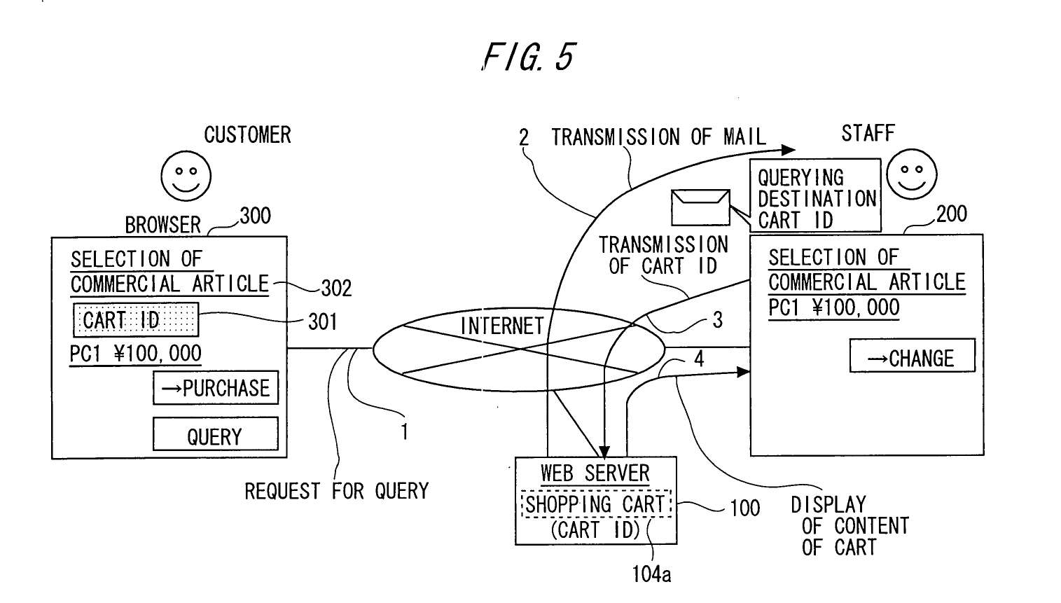

FIGS. 4 and 5 are schematic views on the occasion that the customer queries the commercial product sales trader about a request for the commercial product. In this process example, on the occasion of utilizing the shopping site, the customer is assigned a cart ID 301 as a piece of customer identifying information related to each individual customer by the commercial product sales trader administering the site. This cart ID 301 is stored as a shopping cart related to selected commercial product information 302 related to the commercial product selected by the customer. Further, this cart ID 301 is stored on the storage device 104 of the sales support device 100. Then, this shopping cart is stored on the storage device 104, as a shopping cart database for every piece of customer identifying information of each individual customer.

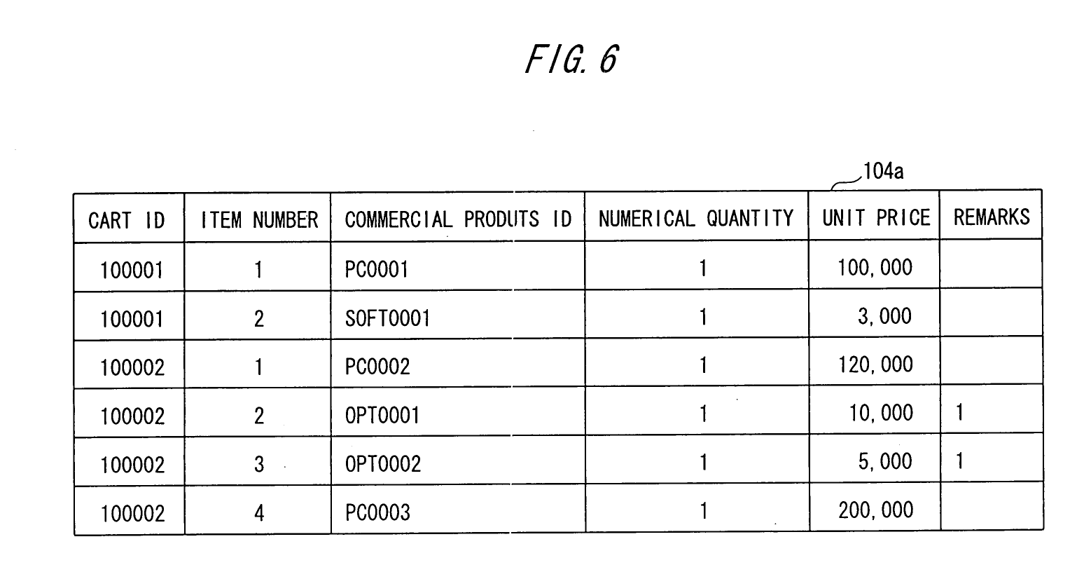

FIG. 6 is, in this process example, one example of a shopping cart database 104a. This shopping cart database 104a is stored with pieces of selected commercial product information of the customer such as commercial product information ID (identifying information), a numerical quantity of the commercial product, or unit prices of the commercial product information, etc. which related to every cart ID of each individual customer.

In the process example, on the occasion of utilizing the shopping cart, there occurs a situation wherein the customer side queries the commercial product sales trader side about the explanation or the request, etc. of the commercial product under consideration for purchasing. At this time, the customer transmits the cart ID to the trader terminal 200 on the side of the commercial product sales trader from the customer terminal 300, thus making a query about the request for the commercial product (an arrowhead mark 1 in FIGS. 4 and 5). Note that on the occasion of transmitting this cart ID, as shown in FIG. 5, the query request from the customer terminal 300 is accepted. Then, the customer terminal 300 dynamically executes the process related to the input of the query from the user by use of the CGI (Common Gateway Interface or JavaScript, etc. towards the trader terminal 200. Note that, if the query request is transmitted from the customer terminal 300 to the sales support device 100, the sales support device 100, upon accepting the query request transmits an E-mail to the trader terminal 200. Namely, the sales support device 100 transferring the cart ID of the customer to the trader terminal 200 (an arrowhead mark 2 in FIG. 5).

Note that on the occasion of transmitting this cart ID, the E-mail from the customer terminal 300 to the trader terminal 200 via the network may also be utilized. Furthermore, in the process example, on the occasion of transmitting this cart ID, as shown in FIG. 4, the information may be transferred by phone from the customer side to the commercial product sales trader side.

On the commercial product sales trader side receiving the cart ID from the customer side, the trader terminal 200 accepts an input of this cart ID. Then, the trader terminal 200 accepting the cart ID of the customer transmits this cart ID to the sales support device 100 via the network (an arrowhead mark 2 in FIG. 4, an arrowhead mark 3 in FIG. 5).

The sales support device 100 accepting the cart ID from the trader terminal 200 connects, related to this cart ID, this trader terminal 200 to the shopping cart stored with the selected commercial product information related to the customer. On the trader terminal 200, when connected to this shopping cart, the selected commercial product information of the customer is displayed as a Browser screen (an arrowhead mark 3 in FIG. 4, an arrowhead mark 4 in FIG. 5) on the screen (not shown) by the Browser application program. Therefore, in the process example, the customer side and the commercial product sales trader side can share the selected commercial product information of the customer.

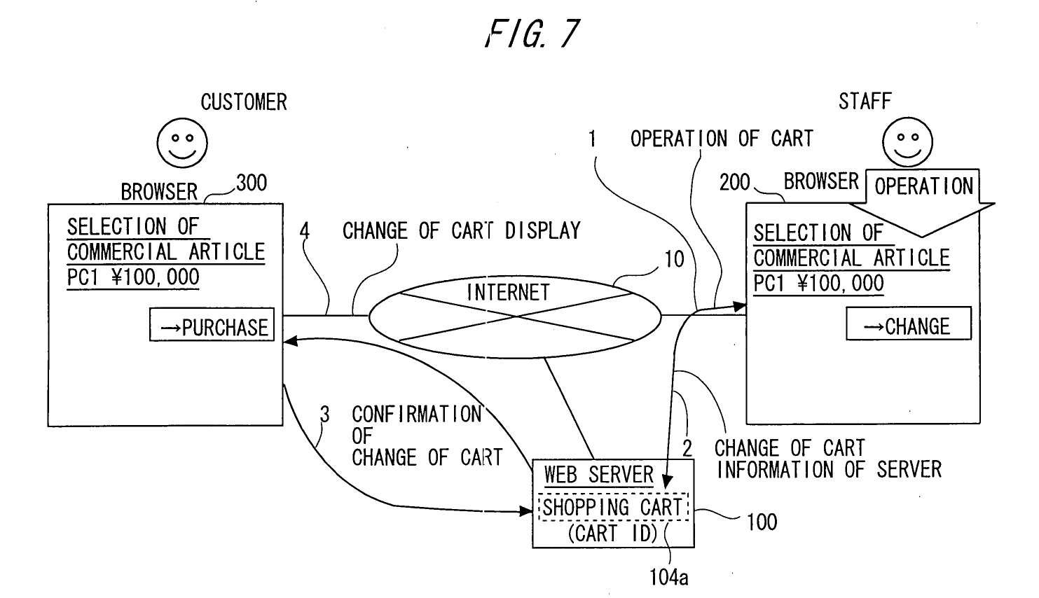

FIG. 7 is a schematic view illustrating a process of rewriting the selected commercial product information of the customer in response to a customer's request in the process example. In the process example, the trader terminal 200 accepts rewriting the selected commercial product information of the customer, related to an operation on the trader terminal 200 by the staff of the commercial product trader (an arrowhead mark 1 in FIG. 7).

The sales support device 100 accepts this rewriting operation via the network from on the trader terminal 200 accepting the rewriting operation of the selected commercial product information by the customer. Then, the sales support device 100, related to the rewriting operation from the commercial product sales trader, rewrites the selected commercial product information of the customer (an arrowhead mark 2 in FIG. 7).

The customer having known that the selected commercial product information of the customer has been rewritten related to the operation of the commercial product sales trader. The customer confirms on the Browser screen of the customer terminal 300 (an arrowhead mark 3 in FIG. 7) that the selected commercial product information of the shopping cart is in the process of being changed. At this time, the customer terminal 300 properly establishes a connection (polling) to the sales support device 100 in order to check whether or not the selected commercial product information has been rewritten related to the operation from on the trader terminal 200. Then, if the selected commercial product information has been rewritten, the customer terminal 300 displays the Browser screen which the updated selected commercial product information is reflected in.

Note that in the process example, the selected commercial product information of the customer can be also rewritten from on the customer terminal 300 (an arrowhead mark 4 in FIG. 7) . At this time, the Browser screen on the trader terminal 200 on the side of the commercial product sales trader is also changed.

It is noted that, in the process example, the rewriting operation accepted by the trader terminal may be set as updated information on the selected commercial product information of the customer. Then, the sales support device 100 may update the selected commercial product information of the customer which related to this piece of updated information.

<Effects of the Embodiment>

The following effects are acquired by actualizing the sales support device according to the embodiment.

In the embodiment, the shopping cart is recorded with states in the middle of shopping by the customer, e.g., a part of intricate combinations of options. The information about the option combinations can be shared with the customer and the commercial product sales trader.

Further, according to the embodiment, the staff of the commercial product sales trader can grasp the shopping situation of the customer and is therefore able to give an advice taking the shopping situation into account.

Moreover, according to the embodiment, the use of the sales support device 100 enables, on the occasion of utilizing the shopping site, the selected commercial product information of the customer to be rewritten from the side of the commercial product sales trader in response to the customer request.

Therefore, according to the sales support device 100, the commercial product sales trader can reflect the customer request in the sales of the commercial products. Namely, according to the sales support device 100, the commercial product that meets the customer's application and needs arising from the request thereof can be offered in response to the customer request. Moreover, according to the sales support device 100, the purchase of the commercial product that meets the request can be proposed in response to the customer request.

<Modified Example>

In the embodiment, the sales support device of the invention has been described by way of one example mainly as on the shopping site using the computer. However, the invention is not limited to this and can be broadly embodied for other types of sales supports related to the commercial products.

In the embodiment, the sales support device, the cart ID is assigned as the customer identifying information related to each individual customer for every shopping by the customer, then this piece of customer identifying information and the selected commercial product information are stored on the shopping database in a way that makes them related to each other. However, the sales support device of the invention is not limited to this.

For example, the commercial product sales trader previously assigns a user ID to the customer, and the sales support device may executes the sales support process in the process example by making this user ID related to the selected commercial product information. In this case, the customer inputs the user ID from on the customer terminal. Then, when the sales support device admits a log-in by collating this user ID with a user ID stored within the storage device, the customer can utilize the shopping site.

What is claimed is:

1. A sales support device comprising:
a unit receiving, from a customer terminal, a selected commercial product information related to a commercial product selected by a customer;
a unit storing a database with a customer identifying information related to the customer, and the selected commercial product information related to the customer, to be related to each other;
a unit receiving the customer identifying information from a trader terminal of a sales trader storing the customer identifying information; and
a unit connecting the trader terminal to the database stored with the selected commercial product information related to the customer in accordance with the customer identifying information.

2. A sales support device according to claim 1, further comprising a unit assigning the customer identifying information, when receiving a request to connection to the device from the customer terminal.

3. A sales support device according to claim 1, further comprising the unit transmitting the customer identifying information to the trader terminal in accordance with an operation toward the customer terminal.

4. A sales support device according to claim 1, further comprising:
a unit receiving a request information about a request for a commercial product desired by the customer from the customer terminal; and
a unit transmitting the request information to the trader terminal.

5. A sales support device according to claim 1, further comprising a unit updating the selected commercial product information stored on the database in accordance with update information given from the trader terminal.

6. An executable-by-computer sales support program making a computer executes:
receiving, from a customer terminal, selected commercial product information related to a commercial product selected by a customer;
storing a database with customer identifying information related to the customer and the selected commercial product information related to the customer, to be related to each other;
receiving the customer identifying information from a trader terminal of a sales trader storing the customer identifying information; and
connecting the trader terminal to the database stored with the selected commercial product information related to the customer in accordance with the customer identifying information.

7. A sales support program according to claim 6, wherein the computer is made to further execute assigning the customer identifying information, when receiving a request to connecting to the device from the customer terminal.

8. A sales support program according to claim 6, wherein the computer is made to further execute transmitting the customer identifying information to the trader terminal in accordance with an operation toward the customer terminal.

9. A sales support program according to claim 6, wherein the computer is made to further execute:
receiving a request information about a request for a commercial product desired by the customer from the customer terminal; and
transmitting the request information to the trader terminal.

10. A sales support program according to claim 6, wherein the computer is made to further execute updating the selected commercial product information stored on the database in accordance with update information given from the trader terminal.

11. A sales support method comprising:
receiving, from a customer terminal, selected commercial product information related to a commercial product selected by a customer;
storing a database with customer identifying information related to the customer, and the selected commercial product information related to the customer, to be related to each other;
receiving the customer identifying information from a trader terminal of a sales trader storing the customer identifying information; and
connecting the trader terminal to the database stored with the selected commercial product information related to the customer in accordance with the customer identifying information.

12. A sales support method according to claim 11, further comprising assigning the customer identifying information, when receiving a request to connecting to the device from the customer terminal.

13. A sales support method according to claim 11, further comprising transmitting the customer identifying information to the trader terminal in accordance with an operation toward the customer terminal.

14. A sales support method according to claim 11, further comprising:
receiving, a request information about a request for a commercial product desired by the customer from the customer terminal; and
transmitting the request information to the trader terminal.

15. A sales support method according to claim 11, further comprising updating the selected commercial product information stored on the database in accordance with update information given from the trader terminal.
